(19) United States
(12) Patent Application Publication
(10) Pub. No.: US 2023/0036448 A1
(43) Pub. Date: Feb. 2, 2023

(54) A CALIBRATION DEVICE FOR A FLOOR SURFACING MACHINE

(71) Applicant: Husqvarna AB, Huskvarna (SE)

(72) Inventor: Andreas Jönsson, Hallsberg (SE)

(21) Appl. No.: 17/787,044

(22) PCT Filed: Oct. 26, 2020
(86) PCT No.: PCT/SE2020/051032

§ 371 Date: Jun. 17, 2022

(30) Foreign Application Priority Data
Dec. 19, 2019 (SE) 1951505-5

(51) Int. Cl. B24B 49/12; B24B 7/18; G01B 21/22; G06T 7/13; G06V 20/50; G06T 7/80

(52) U.S. Cl. CPC B24B 49/12; B24B 7/18; G01B 21/22; G06T 7/13; G06V 20/50; G06T 7/80; G06T 2207/10048; G06T 2207/30244

(57) ABSTRACT

A calibration device (500, 1000) for calibrating a floor surfacing system (200), the calibration device comprising at least four infrared sources (510, 520, 530, 540) arranged separated from each other on a structural member (501) according to a known geometrical configuration, where three of the infrared sources (510, 530, 540) are located in a common plane and where a fourth infrared source (520) is located distanced from the common plane along a normal vector to the common plane, wherein the calibration device (500, 1000) is arranged to be positioned at one or more locations around a perimeter of the surface to be processed in view from an nfrared vision sensor (210), whereby the infrared vision sensor may obtain images of the calibration device at the one or more locations.

### TECHNICAL FIELD

The present disclosure relates to floor grinders and other floor surfacing machines for processing hard material surfaces such as stone and concrete. There are disclosed methods and devices for calibration and control of floor surfacing systems.

### BACKGROUND

Floor grinding relates to the process of smoothing and polishing, e.g., concrete floors by means of a grinding machine. By grinding and polishing hard materials such as concrete and stone, it is possible to achieve a finish resembling that of a polished marble floor. A polished concrete floor is easy to clean and often visually appealing.

Floor grinding may also be used to level a floor surface, i.e., to remove bumps and other imperfections. This may be desired in production facilities where complicated machinery may require a levelled supporting surface.

Floor grinding is, in general, a tediously slow process. The grinding process must often be repeated many times in order to achieve the required surface finish, and each grinding iteration often takes a considerable amount of time. This applies, in particular, to floor grinding at larger venues such as assembly halls and shopping malls.

To increase productivity, automated floor grinders may be used. Automated floor grinders navigate autonomously on the surface to be processed. However, such systems are often associated with issues when it comes to calibration accuracy which affects the autonomous control system negatively. The calibration procedure is also often a tedious process requiring many steps. Consequently, there is a need for efficient and accurate methods for calibrating a floor grinding system.

### SUMMARY

It is an object of the present disclosure to efficient and accurate methods for calibrating a floor grinding system. This object is obtained by a calibration device for calibrating a floor surfacing system. The calibration device comprises at least four infrared sources arranged separated from each other on a structural member according to a known geometrical configuration, where three of the infrared sources are located in a common plane and where a fourth infrared source is located distanced from the common plane along a normal vector to the common plane. The calibration device is arranged to be positioned at one or more locations around a perimeter of the surface to be processed in view from an infrared vision sensor, whereby the infrared vision sensor may obtain images of the calibration device at the one or more locations.

This way a boundary of a surface area to be processed by the floor surfacing system can be determined at the same time as the vision sensor set-up is calibrated. Thus, a more efficient floor grinding process is obtained since the calibration process is made more efficient and also more accurate.

According to some aspects, the calibration device comprises a trigger mechanism arranged to activate the at least four infrared sources. The trigger mechanism may, e.g., be a button on the calibration device or some other trigger mechanism. The infrared vision sensor can then be active continuously and configured to detect the calibration device as soon as the infrared sources are activated by the trigger mechanism. When the calibration device is activated, its position is stored and later processed to complete the calibration routine. The infrared sources may be modulated to transmit an identification code to the vision sensor, thereby allowing the vision sensor to distinguish between a plurality of different calibration devices. This allows several calibration systems to be used in parallel while in view of each other, which is an advantage.

According to other aspects, the calibration device comprises a trigger mechanism arranged to transmit a trigger signal to the infrared vision sensor, which trigger signal is configured to trigger an image capture action by the infrared vision sensor. The trigger mechanism may, e.g., be a button on the calibration device or some other trigger mechanism. The trigger mechanism allows for convenient operation of the calibration device and a more efficient calibration process.

According to aspects, the normal vector intersects one of the infrared sources located in the common plane. Thus, a shape resembling the axes of a Cartesian coordinate system is obtained, which simplifies computation.

According to aspects, the structural member comprises three arms extending from a common intersection point, where each arm comprises a respective infrared source, and where a fourth infrared source is arranged at the intersection point. This particular shape allows for a low complex calibration routine based on finding a surface plane.

According to aspects, an angle between a first arm and a second arm is configurable. The calibration device comprises an angle sensor configured to measure the angle between the first arm and the second arm. This allows to match the shape of the calibration device to corners having angles different from 90 degrees, which is an advantage.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example floor surfacing machine,

FIG. 2 illustrates a floor surfacing operation,

FIG. 3 illustrates projections onto two-dimensional surfaces;

FIG. 4 shows projection of a known shape onto a two-dimensional surface;

FIG. 5 illustrates an example calibration device;

FIG. 6 shows an example use of a calibration device;

FIG. 7 shows an example vision sensor image in two dimensions;

FIG. 8 schematically illustrates a floor grinding calibration operation;

FIGS. 9A-B show two-dimensional images of calibration devices;

FIG. 10 illustrates an example calibration device;

FIG. 11 schematically illustrates a control unit,

FIG. 12 schematically shows a computer program product, and

FIG. 13 is a flow chart illustrating methods.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

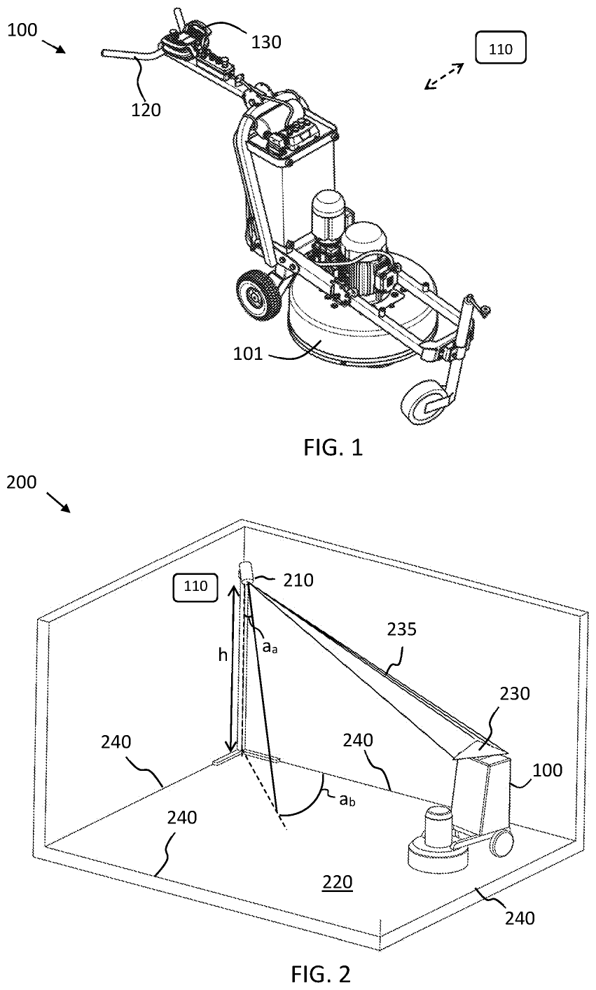

FIG. 1 illustrates a floor grinding machine 100 comprising a planetary head 101 arranged to abrade hard surfaces, such as concrete floors and stone surfaces. The machine 100 can be manually controlled or it may be operated autonomously. During manual control, a driver or machine operator may either control the machine using handles 120, or by remote control 130. Floor grinding machines are known in general and will therefore not be discussed in more detail herein.

A control unit 110 may be used to autonomously control the machine 100. The control unit may be located external to the machine (as shown in FIG. 1) or it can be integrated with the machine 100. The control unit can also be distributed between one or more sub-units on the machine and one or more sub-units configured external to the machine 100. An indoor positioning system based on, e.g., laser beacons or infrared (IR) sources can be used to track the position of the machine, and this position information can be used to guide the machine along a track to process a pre-determined surface area.

An issue with autonomous operation of floor grinders is that the setup of the indoor positioning system is time-consuming. For instance, if an IR system is used, then the exact location and orientation of the IR vision sensor in relation to the surface area to be processed must be determined with high accuracy. After this information has been obtained, it is necessary to measure and mark out the working area and make corrections in the vision sensor tilt angles to calibrate the whole setup.

FIG. 2 illustrates an example scenario 200 where a surface area 220 is to be processed by a floor grinding machine 100. An infra-red vision sensor 210 has been deployed in a corner of the area 220 at a height h and orientation defined by the two angles aₐ and a_{b}, where aₐ is referred to herein as a tilt angle, whereas a_{b} is referred to herein as a direction or bearing angle. The two angles together define the viewing angle of the vision sensor 210. The vision sensor may, e.g., be an IR vision sensor or other sensor configured to sense infrared energy. After the set-up is calibrated, the floor surfacing machine 100 may be guided based on an indoor positioning system comprising a set of IR diodes 230 arranged on the machine 100, by the control unit 110, to process the surface area 220, or it may guide itself if a communication link is set up to the vision sensor such that it can access image data from the vision sensor 210. Lines of sight 235 between the IR sources (or diodes) 220 and the vision sensor have been indicated schematically in FIG. 2.

The present disclosure relates to a calibration device which is portable and convenient to carry around. The calibration device comprises at least four IR sources arranged separated from each other on a structural member according to a known geometrical configuration. The calibration device can be used both to mark the boundary 240 of the surface area 220 to be processed by the machine, and at the same time to calibrate the vision sensor set-up, i.e., to determine the location of the sensor, its height h and viewing angle (aₐ, a_{b}). The device is arranged to be placed at locations around the perimeter of the surface 220, and an image is captured by the vision sensor 210 for each location. Since the system knows exactly what the calibration device looks like in three dimensions (due to the known geometrical configuration of the infrared sources on the calibration device), it can determine from which angle the calibration device is viewed by the vision sensor at each location, and also the distance from the vision sensor 210 to the calibration device based on the scaling of the calibration device in the image (a far-away calibration device will be smaller than a device closer to the vision sensor). This way, the calibration device facilitates both defining the surface area 220 to be treated and at the same time allows for the vision sensor set-up to be calibrated. The calibration device can be used to obtain more information than absolutely necessary to calibrate the system. This is an advantage since each additional measurement or snap-shot of the calibration device improves the calibration accuracy by averaging out measurement errors and the like. Further examples of the calibration process will be given below.

When a vision sensor, such as a camera, is used to capture an image of a three-dimensional object, the shape of that object is projected onto a plane in dependence of the viewing angle and location of the camera.

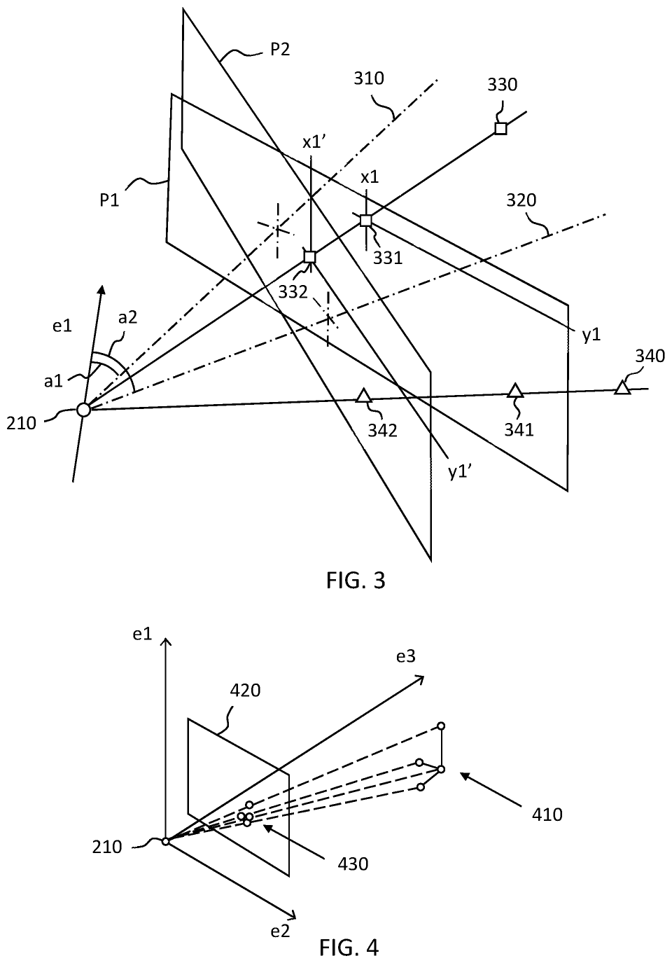

FIG. 3 illustrates two such example projections onto planes. A vision sensor 210 is used to view two infrared sources 330, 340 marked by a square and a triangle. In the first example, the vision sensor 210 is configured with a first viewing angle a1 with respect to some reference axis e1. This viewing angle a1 results in that the two objects 330, 340 are projected onto the plane P1 at two-dimensional coordinates 331 and 341.

If the viewing angle is changed to a2, the relative locations of the two object projections in the image changes to 332 and 342. For instance, the two-dimensional coordinates of the projection of the first object 330 changes from (x1, y1) on plane P1 to (x1′, y1′) on plane P2. From this it is appreciated that, as long as the objects 330, 340 are arranged separated from each other according to a known geometrical configuration, then the viewing angle of the vision sensor 210 can be determined or at least estimated based on the projections of the two objects in the image captured by the vision sensor 210. If the vision sensor 210 is an IR camera, then the projections correspond to pixels in a digital image.

In general, the parameters of the vision sensor set-up are the rotation of the sensor (the viewing angle) and the position of the vision sensor (or translation of the projection center). Suppose that the rotation of the sensor around an X-axis is ϕ, the rotation around a Y-axis is θ, and the rotation around a Z-axis is φ, then the corresponding rotation matrix is

R=R_{X}R_{Y}R_{Z}

where

$${R}_{X} = [ \begin{matrix}1 & 0 & 0 \\ 0 & cos ( ϕ ) & sin ( ϕ ) \\ 0 & - sin ( ϕ ) & cos ( ϕ )\end{matrix} ] \\ {R}_{Y} = [ \begin{matrix}cos ( θ ) & 0 & sin ( θ ) \\ 0 & 1 & 0 \\ - sin ( θ ) & 0 & cos ( θ )\end{matrix} ] \\ {R}_{Z} = [ \begin{matrix}cos ( φ ) & sin ( φ ) & 0 \\ - sin ( φ ) & cos ( φ ) & 0 \\ 0 & 0 & 1\end{matrix} ]$$

In this application, rotation about one axis can be defined as corresponding to vision sensor roll, which can be disregarded. Thus, only two rotation angles need to be considered in this context. A projection of a point in three dimensions to a point in two dimensions can be written (using homogenous coordinates) as

$$( \begin{matrix}{x}^{′} \\ {y}^{′} \\ 1\end{matrix} ) = R ( \begin{matrix}x \\ y \\ z\end{matrix} )$$

where (x′,y′) is the projection in two dimensions from the point (x,y,z), e.g., (x′,y′) may be illuminated pixels in a captured image of an infrared source. A distance dependent scaling factor λ is also introduced for more complex objects. The further away from the vision sensor the object is, the smaller it of course appears in the image, which effect is captured through λ. The scaling factor therefore carries information about the distance from the object to the vision sensor

The calibration devices disclosed herein comprise at least four infrared sources arranged separated from each other on a structural member according to a known geometrical configuration. These infrared sources will result in illuminated pixels in an image captured by the vision sensor 210. The spatial relationship between the infrared sources can be described using a matrix

$$( \begin{matrix}{x}_{1} & {x}_{2} & {x}_{3} & {x}_{4} \\ {y}_{1} & {y}_{2} & {y}_{3} & {y}_{4} \\ {z}_{1} & {z}_{2} & {z}_{3} & {z}_{4}\end{matrix} )$$

where each column represents the location in three dimensions of an infrared source. Changing the viewing angle of the vision sensor is equivalent to applying a rotation to the vectors in the above matrix. Changing the position of the calibration devices with respect to the vision sensor 210 will also show up as a scaling and a rotation of the location vectors. Therefore, the viewing angle and distance to the vision sensor can be determined from the projections of the infrared sources onto the image captured by the vision sensor. To see this, imagine comparing a captured image of a calibration device to a simulated two-dimensional image obtained by rotation, scaling and projection of the known three-dimensional shape onto a two-dimensional surface. By testing a range of rotation angles and scaling, a match can be found between the captured image and the simulated projection—this parameterization corresponds to the viewing angle and vision sensor distance to the calibration device. Of course, the viewing angle and distance can also be determined using known mathematical methods. The mathematics related to projection of three-dimensional objects onto two-dimensional planes is known in general and will therefore not be discussed in more detail herein.

The effect of projecting a set of point sources 410 arranged separated from each other according to a known geometrical configuration onto a plane 420 is schematically illustrated in FIG. 4. Here, the point sources are arranged separated from each other in three dimensions, along axes e1, e2, and e3, which allows the viewing angle to be determined in three dimensions. If the viewing angle changes, or the position of the vision sensor 210 changes, then the relative locations of the pixels 430 in the image also changes. By determining viewing angles for calibration devices deployed at two or more different locations, the position of the vision sensor can be determined as the location where the two (or more) lines (corresponding to the viewing angles from the objects) intersect.

Given a number of snapshots of the calibration device from different angles and at different locations, the viewing angle and the position of the vision sensor can be estimated with increased accuracy. Each snapshot gives two additional equations for each infrared source, one equation for the pixel coordinate x′ and one equation for the pixel coordinate y′. Since the at least four infrared sources on the calibration device are arranged separated from each other on a structural member according to a known geometrical configuration, the relationship between the different infrared sources is known. If many snapshots are available, then the system of equations will be over determined. In this case the estimation of vision sensor set-up and surface area boundary can be performed by, e.g., least squares minimization, constrained optimization, or by any other known optimization technique. Such techniques for determining vision sensor viewing angles from projections are known in general and will therefore not be discussed in more detail herein.

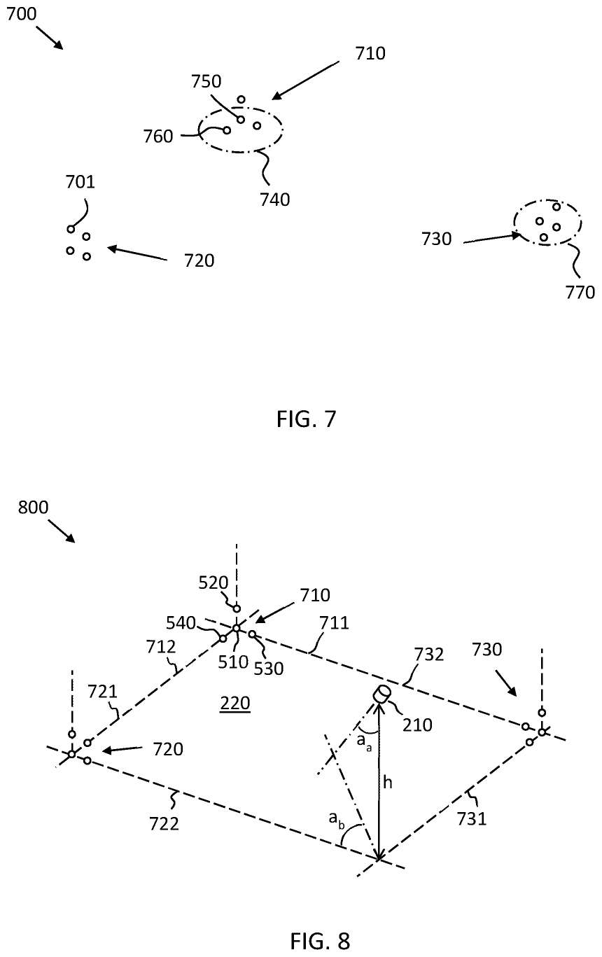

An especially low complex approach for calibrating a floor surfacing system will be discussed below in connection to FIGS. 7-9.

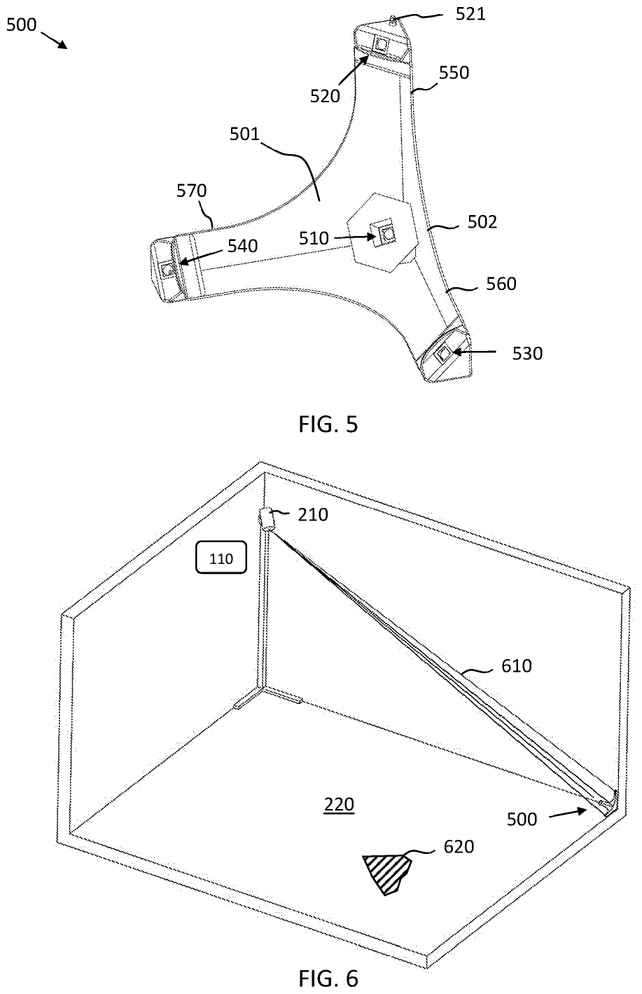

FIG. 5 illustrates an example calibration device 500 for calibrating a floor surfacing system such as the system 200 shown in FIG. 2. The calibration device comprises at least four infrared sources 510, 520, 530, 540 arranged separated from each other on a structural member 501 according to a known geometrical configuration, where three of the infrared sources 510, 530, 540 are located in a common plane and where a fourth infrared source 520 is located distanced from the common plane along a normal vector to the common plane.

The calibration device is arranged to be positioned at one or more locations around a perimeter of the surface 220 to be processed in view from an infrared vision sensor 210, whereby the infrared vision sensor may obtain images of the calibration device at the one or more locations.

When in use, the common plane may be arranged parallel to the surface which is to be processed, i.e., the calibration device can be deployed with the three sensors in the common plane downwards towards the surface 220.

In the example shown in FIG. 5, there are four infrared sources arranged separated from each other to define three axes with 90-degree angles between, i.e., the calibration device 500 thus defines the axles of a coordinate system in three dimensions. The infrared source spacing may be on the order of 10-30 cm, enough for the vision sensor to be able to distinguish the separate infrared sources at all relevant distances. This particular arrangement of infrared sources simplifies computation. The relative positions of the four infrared sources, if the distances to the center diode is a unit length, is

$$( \begin{matrix}0 & 1 & 0 & 0 \\ 0 & 0 & 1 & 0 \\ 0 & 0 & 0 & 1\end{matrix} )$$

where the first column represents the center diode 510, and the other columns represent the other three diodes (one axle per infrared source). In other words, according to some aspects, the normal vector intersects one of the infrared sources located in the common plane. Preferably, the normal vector intersects the center diode 510. This way the four diodes are arranged in a pyramid shape with the center diode forming the peak of the pyramid.

However, it is appreciated that other geometrical configurations than the one shown in FIG. 5 are also applicable. For instance, the arms lengths may be varied, and the angle between the arms need not be 90 degrees. More than four IR sources can also be used. However, the distance between the IR sources are preferably larger than the resolution of the vision sensor at a maximum operating vision sensor range. This operating vision sensor range may, e.g., be on the order of 200-300 meters.

The calibration device 500 is, according to some aspects, arranged to mark the location and spatial configuration of obstacles on the surface 220. For instance, there may be a well or other structure which will interfere with the floor grinding. The calibration device can be deployed in connection to the obstacle and a signal can be generated and transmitted to the control unit 110 indicating the presence of an obstacle. The vision sensor 210 may capture an image showing the location of the obstacle. The spatial configuration of the obstacle can be marked, e.g., by a circle having a pre-determined or configurable radius. The spatial configuration of the obstacle can also be marked by deploying the calibration device at locations along a perimeter of the obstacle and triggering an image capture by the vision sensor at each such location. The control unit 110 can then determine the spatial extension of the obstacle and maneuver the floor grinding machine accordingly. Thus, the control unit may be arranged to receive a signal from the calibration device indicating the presence of an obstacle, and to determine the spatial configuration of the obstacle based on the signal from the calibration device. This signal may be a radio signal, or a modulation applied to the infrared sources (similar to a remote control for a television apparatus).

FIG. 6 schematically indicates the location and spatial configuration of an example obstacle 620. The calibration device 500 has been used to mark the presence of the obstacle, and the control unit 110 is therefore able to maneuver the floor grinding machine 100 to avoid the obstacle.

The calibration device 500 is particularly suitable for calibration of floor surfacing systems to process rectangular surfaces, since the calibration device can be positioned at the corners of the rectangular surface, whereupon the geometry can be easily established by aligning the axes of the coordinate systems defined by the calibration device when located in the different corners.

A scenario like this is schematically illustrated in FIG. 6, where a vision sensor 210 has been positioned in one corner of a rectangular surface 220 to be processed by a floor surfacing system. The calibration device 500 is located in one of the corners, and an image of the calibration device is captured by the vision sensor 210. Lines of sight 610 have been schematically indicated in FIG. 6. Knowing exactly what the calibration device looks like in three dimensions, the viewing angle from the vision sensor 210 to the calibration device can be inferred from the projection of the infrared sources onto the two-dimensional image captured by the vision sensor. If the viewing angle changes, then the image of the calibration device also changes in a predictable and deterministic manner. The distance from the vision sensor 210 to the calibration device can be determined based on the scaling of the projection. Thus, if the pixels illuminated by the infrared sources are close together then the calibration device is far away, and vice versa. To visualize the process, imagine applying a range of rotation matrices with different rotation angles until the projection resembles that in the image captured by the vision sensor, this rotation is then related to the spatial configuration of the calibration device.

With reference again to FIG. 5, the calibration device may comprise a trigger mechanism 521 arranged to activate the infrared sources on the calibration device. The trigger mechanism may, e.g., be a push-button 521 as shown in FIG. 5. The infrared vision sensor can be deployed and activated in a mode where it searches for the infrared sources on the calibration device. Once the infrared sources are activated, the vision sensor detects the location of the calibration device in the captured image and stores the captured data. The calibration device may also be configured to transmit data using the infrared sources, much like a remote control for a television set, to the control unit or to the infrared vision sensor. For instance, when the trigger is activated, the infrared sources may be arranged to transmit a modulated sequence indicating the identity of the calibration device. The infrared vision sensor can then select which calibration devices to record, and which detected calibration devices to ignore. This way two or more calibration systems can be used at the same time in view of each other for two different floor surfacing systems, which is an advantage. The modulated identification signal may also reduce false detections due to background noise and other infrared sources in the environment.

According to some other aspects, the calibration device 500 comprises a trigger mechanism 521 arranged to transmit a trigger signal to the infrared vision sensor 210. The trigger signal is configured to trigger an image capture action by the infrared vision sensor 210. The trigger mechanism may, e.g., be a push-button 521 as shown in FIG. 5, connected to a radio transmitter on the calibration device for remotely controlling the vision sensor. The radio transmission feature may be combined with the infrared source activation feature discussed above or it may be used separately.

In the example of FIG. 5, the structural member 501 comprises three arms 550, 560, 570 extending from a common intersection point 502, where each arm 550, 560, 570 comprises a respective infrared source 520, 530, 540, and where a fourth infrared source 510 is arranged at the intersection point. The three arms are optionally foldable such that the infrared sources 520, 530, 540 meet at a location in front of the common intersection point, similar to a foldable camera stand. This simplifies transportation of the calibration device since it takes up less space when in the folded position.

According to aspects, a first arm 560 and a second arm 570 extend at right angles from a third arm 550. The infrared sources are arranged at the end point of the arms 550, 560, 570. The distance between the fourth infrared source 510 and the other three infrared sources 520, 530, 540 may be between 5 cm and 50 cm, and preferably between 20 cm and 30 cm.

The first arm 560 and the second arm 570 optionally extends at right angles from each other. This type of configuration is illustrated in FIG. 5.

FIG. 10 shows another version of the calibration device 1000 where the first arm 560 and the second arm 570 instead extend at a variable angle A from each other. This means that the arms can be adjusted such that the calibration device can fit in a corner where the angle is different from 90 degrees. This variable angle A can also facilitate defining more irregular surfaces areas 220, i.e., areas having geometric shapes different from a rectangle or a square.

Thus, according to aspects, the angle A between the first arm 560 and the second arm 570 is configurable. The calibration device may also comprise an angle sensor 910 configured to measure the angle A between the first arm 560 and the second arm 570. The output from the angle sensor can be communicated to the vision sensor or to the control unit 110, which then can adjust the determining of, e.g., viewing angle and distance from the vision sensor to the calibration device in dependence of the configurable angle A.

FIG. 7 illustrates infrared sources 700 as may be captured by a vision sensor 210. FIG. 8 shows a resulting calibration and boundary of the surface area 220. The locations of the infrared sources in FIG. 7 and in FIG. 8 are the same. FIGS. 7-9 illustrate a calibration method of low complexity which do not require as extensive computational efforts as the known methods involving three-dimensional vision sensor calibration based on the projections onto planes of known geometric shapes.

FIG. 7 shows three snapshots 710, 720, 730 of the calibration device 500, 1000 at different locations. Knowing that the illuminated pixels 701 captured by a vision sensor 210 originate from a calibration device comprising at least four infrared sources 510, 520, 530, 540 arranged separated from each other on a structural member 501 according to a known geometrical configuration, and that the calibration device has been positioned in sequence in three corners of a rectangular surface area 220, the geometry of the surface area 220 as well as the set-up of the vision sensor 210 can be determined.

First, the lower three pixels 740 in each group or cluster of illuminated pixels is selected. These three pixels correspond to the three infrared sources 510, 530, 540 located in the common plane.

Assuming the calibration device has been positioned on a plane surface, straight lines are then drawn from the center diode pixel 750 through the other two common plane pixels 760. These lines, due to the position of the calibration device in a corner, represents a boundary line of the rectangular surface. These ‘imaginary’ lines 711, 712, 721, 722, 731, 732 are shown in FIG. 8.

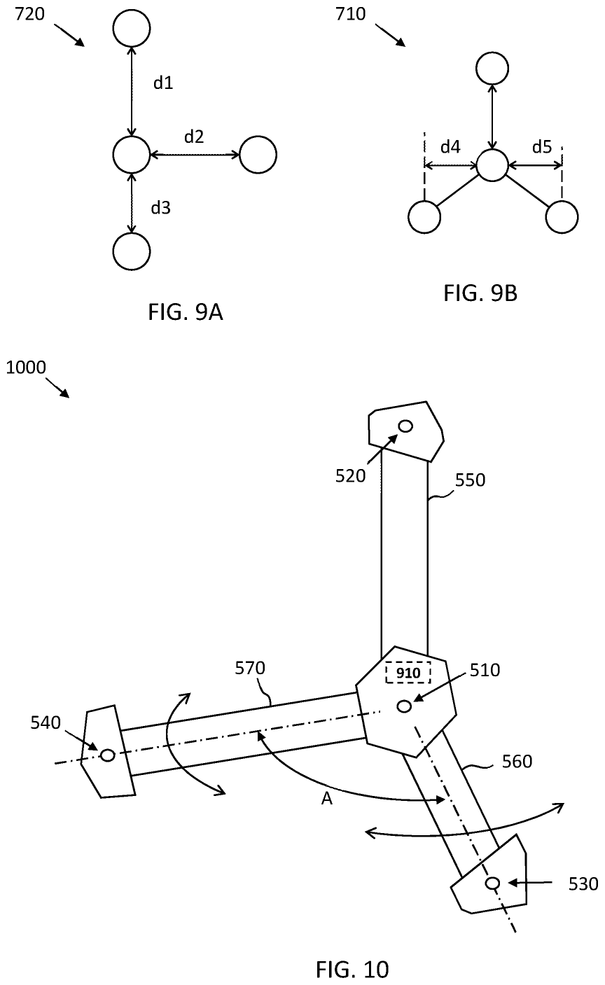

The left-most or the right-most group or cluster of illuminated pixels is then selected 770. These pixels will correspond to a calibration device position along the same wall as the vision sensor is deployed in connection to. This calibration device will be viewed directly from the side from the vision sensor 210, as illustrated in FIG. 9A. The tilt angle aa of the vision sensor 210 can be determined, e.g., based on the relationship between the distances d1 and d3 between pixels in the image, since this relationship will be proportional to tilt. The height h of the vision sensor can then be determined based on the distance d2 (and/or based on the distance d1), which will be proportional to the distance between the vision sensor 210 and the calibration device. Knowing the distance to the vision sensor and the tilt angle, the height h can be determined based on the Pythagorean theorem. FIG. 9B shows the image of the calibration sensor when deployed at the corner opposite to the vision sensor 210. The projection of the infrared sources onto the image from this location can be used to determine the angle component ab in the viewing angle. For instance, the distances d4 and d5 are scaled by a change in the angle component a_{b}.

It is appreciated that more advanced methods can be applied to calibrate the floor surfacing system based on captured images of the calibration device at different locations.

It is appreciated that other shapes than that shown in FIG. 5 can be used for the calibration device. For instance, a more random looking shape may be advantageous, as long as it does not exhibit too much rotational symmetry, since this would complicate the calibration procedure.

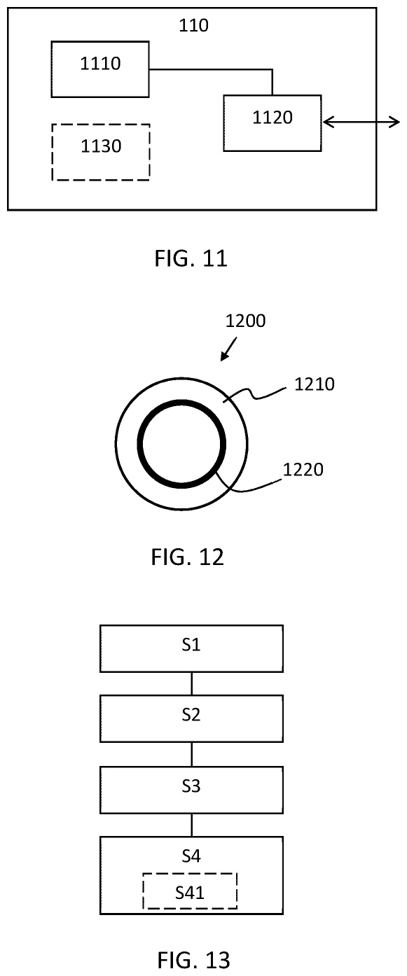

FIG. 11 schematically illustrates, in terms of a number of functional units, the general components of a control unit 110 according to embodiments of the discussions herein. Processing circuitry 1110 is provided using any combination of one or more of a suitable central processing unit CPU, multiprocessor, microcontroller, digital signal processor DSP, etc., capable of executing software instructions stored in a computer program product, e.g. in the form of a storage medium 1130. The processing circuitry 1110 may further be provided as at least one application specific integrated circuit ASIC, or field programmable gate array FPGA.

Particularly, the processing circuitry 1110 is configured to cause the control unit 110 to perform a set of operations, or steps, such as the methods discussed in connection to FIG. 6 and the discussions above. For example, the storage medium 1130 may store the set of operations, and the processing circuitry 1110 may be configured to retrieve the set of operations from the storage medium 1130 to cause the control unit to perform the set of operations. The set of operations may be provided as a set of executable instructions. Thus, the processing circuitry 1110 is thereby arranged to execute methods as herein disclosed.

The storage medium 1130 may also comprise persistent storage, which, for example, can be any single one or combination of magnetic memory, optical memory, solid state memory or even remotely mounted memory.

The control unit 110 may further comprise an interface 1120 for communications with at least one external control unit. As such the interface 1120 may comprise one or more transmitters and receivers, comprising analogue and digital components and a suitable number of ports for wireline or wireless communication.

The processing circuitry 1110 controls the general operation of the control unit 110, e.g., by sending data and control signals to the interface 1120 and the storage medium 1130, by receiving data and reports from the interface 1120, and by retrieving data and instructions from the storage medium 1130. Other components, as well as the related functionality, of the control node are omitted in order not to obscure the concepts presented herein.

Consequently, there is disclosed herein a control unit 110 for calibrating a floor surfacing system 200. The control unit comprises an interface 1120 for receiving infrared image data from an infrared vision sensor 210 and processing circuitry 1110, wherein the infrared image data comprises pixel locations in two dimensions indicating locations of a calibration device around a perimeter of a surface area 220 to be treated by the floor surfacing system 200. The calibration device comprises at least four infrared sources 510, 520, 530, 540 arranged separated from each other on respective structural members 501 according to a pre-determined geometrical configuration, wherein the processing circuitry 1110 is configured to determine a spatial configuration h, aₐ, a_{b} of the infrared vision sensor 210 based on the pixel locations and on the pre-determined geometrical configuration.

According to some aspects, the processing circuitry 1110 is further arranged to determine a boundary of the surface area 220 to be treated by the floor surfacing system 200 based on the pixel locations.

The control unit 110 is optionally arranged to receive data from a calibration device 1000 indicating an angle A between a first arm 560 and a second arm 570 of the calibration device, and to determine the boundary of the surface area 220 to be treated by the floor surfacing system 200 based also on the angle A.

There is furthermore disclosed herein a system for calibrating a floor surfacing system 200. The system comprises one or more calibration devices 500, 1000 according to the discussion above, a control unit 110 as shown in FIG. 11, and the infrared vision sensor 210.

FIG. 12 illustrates a computer readable medium 1210 carrying a computer program comprising program code means 1220 for performing the methods illustrated in FIG. 13, when said program product is run on a computer. The computer readable medium and the code means may together form a computer program product 1200.

FIG. 12 is a flow chart illustrating methods which summarize the discussion above. There is shown a method for calibrating a floor surfacing system 200. The method comprises deploying S1 a calibration device 500, 1000 comprising at least four infrared sources 510, 520, 530, 540 arranged separated from each other on a structural member 501 according to a pre-determined geometrical configuration, in sequence, at positions along a boundary of a surface area 220 to be treated by the floor surfacing system 200. The method also comprises triggering S2, for each position, an image capture action by an infrared vision sensor 210 to record the configuration of the at least four infrared sources 510, 520, 530, 540 as pixel locations, and determining S3 a spatial configuration h, aₐ, a_{b} of the infrared vision sensor 210 based on the pixel locations and on the pre-determined geometrical configuration.

According to some aspects, the method also comprises determining S4 a boundary of the surface area 220 to be treated by the floor surfacing system 200 based on the pixel locations and on the pre-determined geometrical configuration.

According to some such aspects, the boundary of the surface area 220 to be treated by the floor surfacing system 200 is determined S41 under the assumption of a flat surface supporting the calibration device 500, 1000 at each location.

1. A calibration device for calibrating a floor surfacing system, the calibration device comprising at least four infrared sources arranged separated from each other on a structural member according to a known geometrical configuration, wherein three of the infrared sources are located in a common plane and where a fourth infrared source is located distanced from the common plane along a normal vector to the common plane, wherein the calibration device is arranged to be positioned at one or more locations around a perimeter of the surface to be processed in view from an infrared vision sensor, and wherein the infrared vision sensor obtain images of the calibration device at the one or more locations.

2. The calibration device according to claim 1, further comprising a trigger mechanism arranged to activate the at least four infrared sources.

3. The calibration device according to claim 1, further comprising a trigger mechanism arranged to transmit a trigger signal to the infrared vision sensor, the trigger signal being configured to trigger an image capture action by the infrared vision sensor.

4. The calibration device according to claim 1, wherein the normal vector intersects one of the infrared sources located in the common plane.

5. The calibration device according to claim 1, wherein the structural member comprises three arms extending from a common intersection point, wherein each arm comprises a respective one of the three of the infrared source, and wherein the fourth infrared source is arranged at the intersection point.

6. The calibration device according to claim 5, wherein a first arm and a second arm extend at right angles from a third arm.

7. The calibration device according to claim 6, wherein the first arm and the second arm extend at right angles from each other.

8. The calibration device according to claim 6, wherein an angle between the first arm and the second arm is configurable, wherein the calibration device comprises an angle sensor configured to measure the angle between the first arm and the second arm.

9. The calibration device according to claim 1, comprising an input device arranged to mark an obstacle on the surface area, and a transmitter arranged to transmit a signal from the calibration device to a control unit indicating presence of an obstacle.

10. A control unit for calibrating a floor surfacing system, the control unit comprises an interface for receiving infrared image data from an infrared vision sensor and processing circuitry, wherein the infrared image data comprises pixel locations in two dimensions indicating locations of a calibration device around a perimeter of a surface area to be treated by the floor surfacing system, the calibration device comprising at least four infrared sources arranged separated from each other on respective structural members according to a pre-determined geometrical configuration, wherein the processing circuitry is configured to determine a spatial configuration of the infrared vision sensor based on the pixel locations and on the pre-determined geometrical configuration.

11. The control unit according to claim 10, wherein the processing circuitry is further arranged to determine a boundary of the surface area to be treated by the floor surfacing system based on the pixel locations.

12. The control unit according to claim 11, arranged to receive data from a calibration device indicating an angle between a first arm and a second arm of the calibration device, and to determine the boundary of the surface area to be treated by the floor surfacing system based also on the angle.

13. The control unit according to claim 10, wherein the control unit is arranged to receive a signal from the calibration device indicating the presence of an obstacle, and to determine the spatial configuration of the obstacle based on the signal from the calibration device.

14. A system for calibrating a floor surfacing system, comprising one or more calibration devices according to claim 1, a control unit, and the infrared vision sensor.

15. A method for calibrating a floor surfacing system, the method comprising:
deploying a calibration device comprising at least four infrared sources arranged separated from each other on a structural member according to a pre-determined geometrical configuration, in sequence, at positions along a boundary of a surface area to be treated by the floor surfacing system,
triggering, for each position, an image capture action by an infrared vision sensor to record the pre-determined geometrical configuration of the at least four infrared sources as pixel locations, and
determining a spatial configuration of the infrared vision sensor based on the pixel locations and on the pre-determined geometrical configuration.

16. The method according to claim 15, comprising determining a boundary of the surface area to be treated by the floor surfacing system based on the pixel locations and on the pre-determined geometrical configuration.

17. The method according to claim 16, wherein the boundary of the surface area to be treated by the floor surfacing system is determined under an assumption of a flat surface supporting the calibration device at each location.

18. A computer program comprising program code means for performing the steps of claim 15 when said program is run on a computer or on processing circuitry of a control unit.
